(19) United States
(12) Patent Application Publication
(10) Pub. No.: US 2018/0074159 A1
(43) Pub. Date: Mar. 15, 2018

(54) DETERMINING A LOCATION OF AN ELECTRONIC TAG IN AN AREA USING PROBABILISTIC METHODS

(71) Applicant: HCL Technologies Limited, Noida (IN)

(72) Inventors: Sajana MULLESSARY, Bengaluru (IN); Ravi Kishore B, Chennai (IN); Ravi Chandra Sekhar NEMALA, Bengaluru (IN)

(21) Appl. No.: 15/697,463

(22) Filed: Sep. 7, 2017

(30) Foreign Application Priority Data
Sep. 14, 2016 (IN) 201611031292

(51) Int. Cl. G01S 5/02; G06K 7/10; G01S 5/14

(52) U.S. Cl. CPC G01S 5/0278; G01S 5/14; G06K 7/10366

(57) ABSTRACT

The present disclosure relates to system(s) and method(s) to determine a location of an electronic tag in an area. The system is configured to transmit a series or radio messages and receive one or more response radio messages from an electronic tag, through a transceiver. Further, the system is configured to determining metadata corresponding to each response radio message and distance covered by the transceiver at the time of transmitting the radio message. Based on the distance covered and metadata associated with each response radio message, the system is configured to determine the exact location of the electronic tag in an area.

### CROSS-REFERENCE TO RELATED APPLICATIONS AND PRIORITY

The present application claims priority from Indian Patent Application No. 201611031292 filed on 14 Sep. 2016, the entirety of which is hereby incorporated by reference.

### TECHNICAL FIELD

The present disclosure in general relates to the field of location tracking. More particularly, the present invention relates to determining location information of an electronic tag based on characteristic of signal received from the electronic tag.

### BACKGROUND

Electronic tags such as the Radio Frequency Identification (RFID) tags are finding several industrial applications due to their low cost and research support. Passive RFID tags are available at a very low cost and collect energy from a nearby RFID reader's interrogating radio waves. The RFID tags contain electronically stored information and respond to the RFID reader's interrogation with the stored information. RFID does not require line of sight as compared to a barcode.

The RFID tags can be used in a range of different applications. One of the applications is to detect location of different goods in a store house. The RFID tag may be placed on the goods in a store, and an RFID reader may be used to scan the location of the goods placed at different shelves in the store. In another implementation, RFID tags may be attached to assets, in an aircraft cabin, which have to be present at certain locations to meet regulatory and technical requirements. Life vest is one such asset that must be located under each of the passenger seat. Regular periodic audits are performed manually to ensure this regulatory requirement. These audits are time consuming as they are performed manually. To automate this process, RFID tags may be attached to each of the assets and scanned manually using an RFID reader. However, scanning of the RFID tag at each asset is time consuming and may lead to a lot of manual errors.

### SUMMARY

This summary is provided to introduce aspects related to systems and methods for determining a location of an electronic tag in an area and the aspects are further described below in the detailed description. This summary is not intended to identify essential features of the claimed subject matter nor is it intended for use in determining or limiting the scope of the claimed subject matter.

In one embodiment, a system for determining a location of an electronic tag in an area is illustrated. The system comprises a transceiver, a processor coupled to a memory, wherein the processor is configured to execute programmed instructions stored in the memory. In one embodiment, the transceiver is connected to the processor. The processor may signal the transceiver to transmit a series of radio messages to an electronic tag in the vicinity of the transceiver. In one embodiment, the transceiver is configured to travel a distance after transmitting each radio message from the series of radio messages. Further, the transceiver is configured to receive one or more response radio messages, corresponding to one or more radio messages of the series of radio messages, from the electronic tag. Further, the processor may execute a programmed instruction stored in the memory for determining metadata corresponding to each response radio message and distance covered by the transceiver at the time of transmitting the radio message. The metadata may include a signal phase and a signal strength corresponding to the response radio message. Further, the processor may execute a programmed instruction stored in the memory for analyzing the distance covered by the transceiver and the metadata for each response radio message using a probabilistic model and determine a probability of occurrence of the electronic tag at each location associated with the area. Further, the processor may execute a programmed instruction stored in the memory for identifying a target location corresponding to the electronic tag, from the set of locations in the area, based on the probability of occurrence corresponding to each location in the area.

In one embodiment, a processor implemented method for determining a location of an electronic tag in an area is illustrated. The method may comprise transmitting a series of radio messages to an electronic tag in the vicinity of a transceiver, wherein the series of radio messages are transmitted through a transceiver. In one embodiment, the transceiver is configured to travel a distance after transmitting each radio message from the series of radio messages. The method may further comprise receiving one or more response radio messages from the electronic tag through the transceiver. The one or more response radio message may correspond to one or more radio messages of the series of radio messages. The method may further comprise determining metadata corresponding to the response radio message and distance covered by the transceiver at the time of transmitting the radio message. The metadata may include a signal phase and a signal strength corresponding to the response radio message, and for each response radio message. The method may further comprise analyzing the distance covered by the transceiver and the metadata for each response radio message using a probabilistic model to determine a probability of occurrence of the electronic tag at each location associated with the area. The method may further comprise identifying a target location corresponding to the electronic tag, from the set of locations in the area, based on the probability of occurrence corresponding to each location in the area.

In one embodiment, a non-transitory computer readable medium embodying a program executable in a computing device for determining a location of an electronic tag in an area is illustrated. The program comprises a program code for transmitting a series of radio messages to an electronic tag in the vicinity of a transceiver, wherein the series of radio messages are transmitted through a transceiver. In one embodiment, the transceiver is configured to travel a distance after transmitting each radio message from the series of radio messages. The program comprises a program code for receiving one or more response radio messages from the electronic tag through the transceiver. The one or more response radio message may correspond to one or more radio messages of the series of radio messages. The program comprises a program code for determining metadata corresponding to the response radio message and distance covered by the transceiver at the time of transmitting the radio message. The metadata includes a signal phase and a signal strength corresponding to the response radio message, and for each response radio message. The program comprises a program code for analyzing the distance covered by the transceiver and the metadata for each response radio message using a probabilistic model to determine a probability of occurrence of the electronic tag at each location associated with the area. The program comprises a program code for identifying a target location corresponding to the electronic tag, from the set of locations in the area, based on the probability of occurrence corresponding to each location in the area.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a network implementation of a system configured to determine location of an electronic tag in an area, in accordance with an embodiment of the present subject matter.

FIG. 2 illustrates the system configured to determine the location of the electronic tag in the area, in accordance with an embodiment of the present subject matter.

FIG. 3 illustrates a flow diagram to determine the location of the electronic tag in the area, in accordance with an embodiment of the present subject matter.

### DETAILED DESCRIPTION

The present disclosure relates to a system for determining a location of an electronic tag in an area. The system comprises a transceiver, a processor coupled to a memory. The processor is configured to execute programmed instructions stored in the memory. In one embodiment, the transceiver is connected to the processor through wireless communication channel such as Wi-Fi or Bluetooth. The processor may signal the transceiver to transmit a series of radio messages to an electronic tag in the vicinity of the transceiver.

In one embodiment, the transceiver is configured to travel a distance after transmitting each radio message from the series of radio messages. The transceiver may be mounted over a robotic platform. The processor may instruct the robotic platform to travel along a predefined path and cover the distance after transmitting each radio message from the series of radio messages. Further, the transceiver is configured to receive one or more response radio messages, corresponding to one or more radio messages of the series of radio messages, from the electronic tag.

Further, the processor may execute a programmed instruction stored in the memory for determining metadata corresponding to each response radio message and distance covered by the transceiver at the time of transmitting the radio message. The metadata may include a signal phase and a signal strength corresponding to the response radio message. Further, the distance covered by the transceiver may be computed from a predefined starting point in the area. Further, the processor may execute a programmed instruction stored in the memory for analyzing the distance covered by the transceiver and the metadata for each response radio message using a probabilistic model and determine a probability of occurrence of the electronic tag at each location associated with the area.

Further, the processor may execute a programmed instruction stored in the memory for identifying a target location corresponding to the electronic tag, from the set of locations in the area, based on the probability of occurrence corresponding to each location in the area.

While aspects of described system and method for determining location of the electronic tag in the area may be implemented in any number of different computing systems, environments, and/or configurations, the embodiments are described in the context of the following exemplary system.

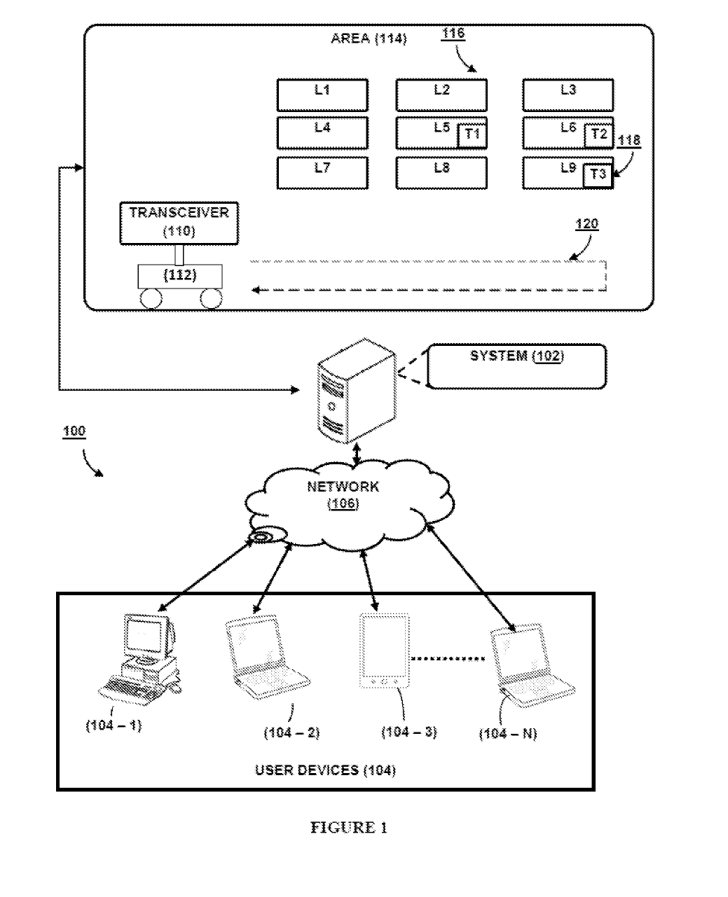

Referring now to FIG. 1, a network implementation 100 of a system 102 to determining a location of an electronic tag in an area is disclosed. Although the present subject matter is explained considering that the system 102 is implemented on a server, it may be understood that the system 102 may also be implemented in a variety of computing systems, such as a laptop computer, a desktop computer, a notebook, a workstation, a mainframe computer, a server, a network server, and the like. In one implementation, the system 102 may be implemented in a cloud-based environment. It will be understood that the system 102 may be accessed by a user through one or more user devices 104-1, 104-2 . . . 104-N, collectively referred to as user devices 104 hereinafter, or applications residing on the user devices 104. Examples of the user devices 104 may include, but are not limited to, a portable computer, a personal digital assistant, a handheld device, and a workstation, file server, version control servers, bugs tracking servers. The user devices 104 are communicatively coupled to the system 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

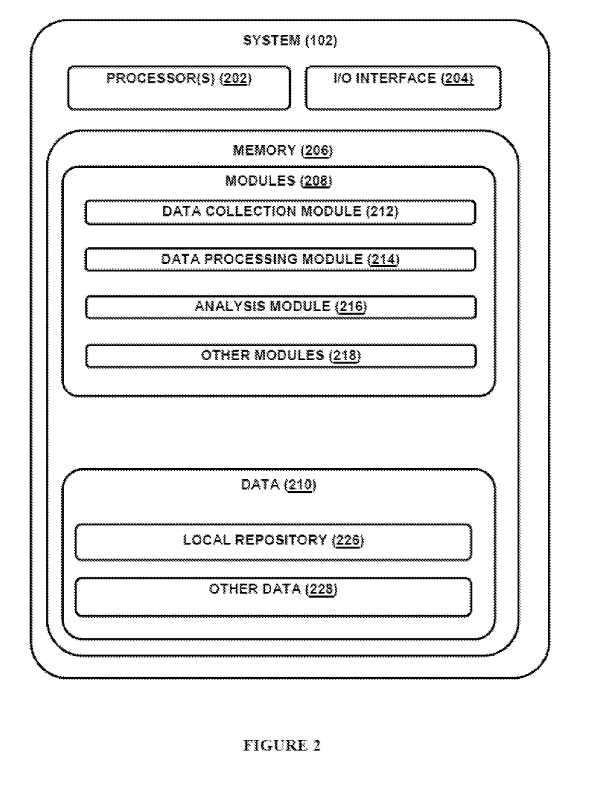

Further, the system 102 is configured to communicate with a robotic platform 112 and a transceiver 110 mounted on the robot platform 112. In one implementation, the robotic platform 112 may be placed in an area 114, wherein the robotic platform 112 is configured to travel a predefined path 120 in the area 114. The area 114 may be aircraft cabin, a shopping mall, a warehouse, a goods store, and the like. The area 114 may comprise a set of locations 116. The set of locations 116 may in the form of shelves or compartments in the area 114. In one embodiment, the set of location 116 may have a fixed layout. For example, in case a particular aircraft model cabinet with a fixed arrangement of seats, the arrangement of seats may be considered as fixed layout, wherein an electronic tag 118 is attached to the seats or life vests kept below each seat. The fixed layout information may be stored in a repository, as background data, to be referred by the system 102. In one embodiment, the predefined path 120 may be generated based on the layout information associated with the area 114. Further, the electronic tag 118 may be placed at a location L5 in the area 114. The electronic tag 118 may be in the form of a passive RFID tag configured to communicate with the transceiver 110. In a similar manner, other RFID tags may be placed at other locations in the area 114. In one embodiment, the system 102 is configured to transmit a series of radio messages, to the electronic tag 118, through the transceiver 110 and receive one or more response radio messages from the electronic tag 118. It is to be noted that for every radio message, only one response radio message is generated by the electronic tag 118. The electronic tag 118 may respond to each of the one or more radio messages, from the series of radio messages, with a single response radio message. Further, based on the metadata associated with each of the response radio signals and the distance covered by the transceiver 110, the system 102 is configured to determine the target location at which the electronic tag 118 is placed. The process of determining target location of the electronic tag 118 in the area 114 is further elaborated with respect to FIG. 2.

Referring now to FIG. 2, the system 102 is illustrated in accordance with an embodiment of the present subject matter. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with a user directly or through the user devices 104. Further, the I/O interface 204 may enable the system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 include routines, programs, objects, components, data structures, etc., which perform particular tasks, functions or implement particular abstract data types. In one implementation, the modules 208 may include a data collection module 212, a data processing module 214, an analysis module 216, and other modules 218. The other modules 218 may include programs or coded instructions that supplement applications and functions of the system 102. The data 210, amongst other things, serves as a repository for storing data processed, received, and generated by one or more of the modules 208. The data 210 may also include a local repository 226, and other data 228. The local repository 226 is configured to store predefined path and fixed layout information of the set of locations 116 and metadata corresponding to each response radio message.

In one embodiment, the data collection module 212 is configured to fetch fixed layout information and predefined path 120 from the local repository 226 and communicate with the robotic platform 112 and the transceiver 110 mounted on the robot platform 112. In one implementation, the robotic platform 112 may be placed in the area 114. The area 114 may comprise a set of locations 116. The set of locations 116 may in the form of shelves, compartments, seats and the like in the area 114. In one example, the electronic tag 118 may be placed at a location (L5) in the area 114. The electronic tag 118 may be in the form of a passive RFID tag configured to communicate with the transceiver 110. In a similar manner, other electronic tags with unknown location may be placed in the area 114. In one embodiment, the data collection module 212 is configured to transmit a series of radio messages, to the electronic tag 118, through the transceiver 110. In one embodiment, the transceiver 110 is configured to travel a distance, corresponding to the predefined path 120, after transmitting each radio message from the series of radio messages. In one embodiment, the robotic platform 112 may be operated by the data collection module 212 for maneuvering the transceiver to cover the distance after transmitting each radio message from the series of radio messages. Once a series of radio messages are transmitted, the transceiver 110 is configured to receive one or more response radio messages from the electronic tag 118. It is to be noted that for every radio message, only one response radio message is generated by the electronic tag 118. If the electronic tag 118 is in the vicinity (range) of the transceiver 110, the electronic tag 118 is able to receive a radio message and respond with a single response radio message. If the electronic tag 118 is able to receive multiple radio messages, the electronic tag 118 responds to each radio message received with a single response radio message. The response radio messages may include identification information of the electronic tag 118. In a similar manner, each electronic tag in the area 114 may respond with a response radio message containing the identification information associated with the respective electronic tag. Further, the response radio messages received from each of the individual electronic tags are processed individually. The processing is performed by the data processing module 214.

The data processing module 214 is configured to analyse each response radio message and determine metadata corresponding to each response radio message, and a distance covered by the transceiver 110 at the time of transmitting the radio message. In one embodiment, the metadata may include a signal phase and a signal strength corresponding to the response radio message. The metadata may also include an antenna angle of the transceiver 110 and time of response corresponding to the response radio message.

Once the metadata and the distance corresponding to each response radio message is determined, in the next step, the analysis module 216 is configured to analyze the distance covered by the transceiver 110 and the metadata for each response radio message using a probabilistic model. The probabilistic model enables to determine a probability of occurrence of the electronic tag at each location from the set of locations 116 associated with the area 114.

In one embodiment, the probabilistic model may be configured to determine probability of occurrence based on a machine learning model. The machine learning model may be built using supervised analysis of training data. Further, the training data may be generated by analyzing response radio messages captured from a set of electronic tags with known location information in the area 114. Once the training data is generated, the machine learning model may be configured to analyze the training data for generating signal characteristics corresponding to each electronic tag in the area 114 with known location information. These signal characteristics corresponding to each electronic tag with a known location are compared with the metadata corresponding to the response radio messages and distance covered by the transceiver 110 for determining the probability of occurrence of a particular tag at a particular location. For instance, if the probabilistic model identifies that the signal characteristics corresponding to an electronic tag (T1) with a known location (L5) are similar to the metadata of the response radio message and distance covered by the transceiver 110, then probabilistic model may determine that the probability of occurrence of the electronic tag under analysis at location L5 is very high.

Further, the analysis module 216 is configured to identify a target location corresponding to the electronic tag, from the set of locations 116 in the area 114, based on the probability of occurrence corresponding to each location in the area 114. For instance, the analysis module 216 may compare the probability of occurrence corresponding to each location and determine a location with the highest probability of occurrence as the target location corresponding to the electronic tag under analysis.

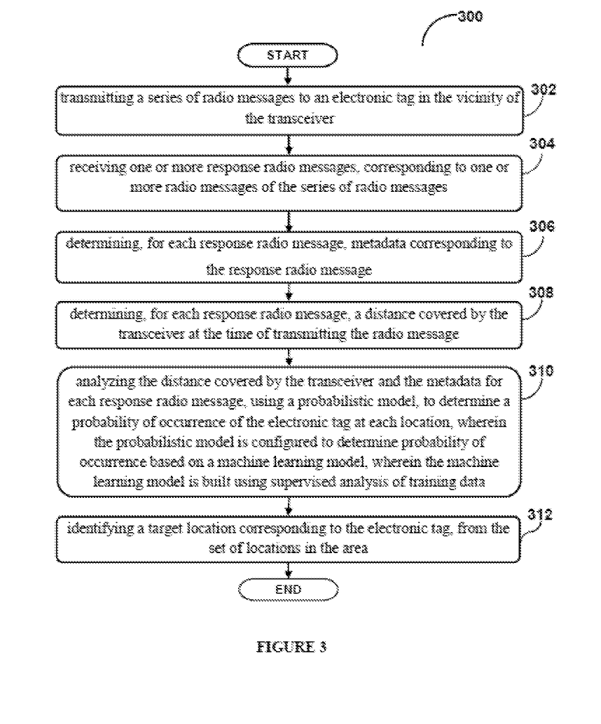

Further, based on the metadata associated with each of the response radio signals and the distance covered by the transceiver 110, the system 102 is configured to determine the location at which the tag is placed. The method for determining a location of an electronic tag in an area is further illustrated with respect to the block diagram of FIG. 3.

Referring now to FIG. 3, a method 300 for determining a location of an electronic tag in an area is disclosed, in accordance with an embodiment of the present subject matter. The method 300 may be described in the general context of computer executable instructions. Generally, computer executable instructions can include routines, programs, objects, components, data structures, procedures, modules, functions, and the like, that perform particular functions or implement particular abstract data types. The method 300 may also be practiced in a distributed computing environment where functions are performed by remote processing devices that are linked through a communications network. In a distributed computing environment, computer executable instructions may be located in both local and remote computer storage media, including memory storage devices.

The order in which the method 300 is described is not intended to be construed as a limitation, and any number of the described method blocks can be combined in any order to implement the method 300 or alternate methods. Additionally, individual blocks may be deleted from the method 300 without departing from the spirit and scope of the subject matter described herein. Furthermore, the method 300 can be implemented in any suitable hardware, software, firmware, or combination thereof. However, for ease of explanation, in the embodiments described below, the method 300 may be considered to be implemented in the above described system 102.

At block 302, the data collection module 212 is configured to communicate with the robotic platform 112 and the transceiver 110 mounted on the robot platform 112. In one implementation, the robotic platform 112 may be placed in the area 114. The area 114 may comprise a plurality of locations 116. The locations 116 may in the form of shelves or compartments in the area 114. Further, the electronic tag 118 may be placed at a location (L5) in the area 114. The electronic tag 118 may be in the form of a passive RFID tag configured to communicate with the transceiver 110. In one embodiment, the data collection module 212 is configured to transmit a series of radio messages, to the electronic tag 118, through the transceiver 110. In one embodiment, the transceiver 110 is configured to travel a distance after transmitting each radio message from the series of radio messages. In one embodiment, the robotic platform 112 may be operated by the data collection module 212 for maneuvering the transceiver to cover the distance after transmitting each radio message from the series of radio messages.

At block 304, once a series of radio messages are transmitted, the data collection module 212 is configured to receive one or more response radio messages from the electronic tag 118 through the transceiver 110. It is to be noted that for every radio message, only one response radio message is generated by the electronic tag 118. If the electronic tag 118 is in the vicinity (range) of the transceiver 110, the electronic tag 118 is able to receive a radio message and respond with a single response radio message. If the electronic tag 118 is able to receive multiple radio messages, the electronic tag 118 responds to each radio message received with a single response radio message.

At block 306 and 308, the data processing module 214 is configured to analyse each response radio message and determine metadata corresponding to each response radio message. The data processing module 214 is also configured to determine a distance covered by the transceiver at the time of transmitting the radio message. In one embodiment, the metadata may include a signal phase and a signal strength corresponding to the response radio message. The metadata may also include an antenna angle of the transceiver and time of response corresponding to the response radio message.

At block 310, once the metadata and the distance corresponding to each response radio message is determined, in the next step, the analysis module 216 is configured to analyze the distance covered by the transceiver 110 and the metadata for each response radio message using a probabilistic model. The probabilistic model enables to determine a probability of occurrence of the electronic tag at each location 116 associated with the area 114.

In one embodiment, the probabilistic model may be configured to determine probability of occurrence based on a machine learning model. The machine learning model may be built using supervised analysis of training data. Further, the training data may be generated by analyzing response radio messages captured from a set of electronic tags with known location information in the area 114. The first step performed by the analysis module 216 is training the model using any machine learning method for predictive analysis. In one embodiment, the model, based on SVM with RBF kernel, may be trained using several sets of training data. In the training data, the location of the tags is available. With sufficient amount of training, the accuracy of the model is improved. When the test data is fed to this model, it predicts the probabilities of the tag being located in each of the available locations.

Once the training data is generated, the machine learning model may be configured to analyze the training data for generating signal characteristics corresponding to each electronic tag from the set of electronic tags. These signal characteristics corresponding to each electronic tag with a known location are compared with the metadata for response radio message and distance covered by the transceiver 110 for determining the probability of occurrence of a particular tag at a particular location. For instance, if the probabilistic model identifies that the signal characteristics corresponding to an electronic tag (T1) with a known location (L5) are similar to the metadata of the response radio message and distance covered by the transceiver 110, then probabilistic model may determine that the probability of occurrence of the electronic tag under analysis at location L5 is very high. In one embodiment, a probability model is built using combination of distance, signal phase and RSSI. In one example, the probabilistic model may start processing the metadata of the response radio message and distance covered by the transceiver 110 with a belief model where the electronic tag could be in any of the set of locations 116 with equal probability. This probability model provides a probability for each of the sample indicating the probability that the tag is present in any of the locations. Further, the probability model refines the belief based on each entry in the metadata and distance vector corresponding to the electronic tag 118. At the end of the input samples for this tag, a clear convergence of probability is observed pointing to the target location of the tag with a high confidence.

At block 312, the analysis module 216 is configured to identify a target location corresponding to the electronic tag, from the set of locations 116 in the area 114, based on the probability of occurrence corresponding to each location in the area 114. For instance, the analysis module 216 may compare the probability of occurrence corresponding to each location and determine a location with the highest probability of occurrence as the target location corresponding to the electronic tag under analysis.

In one exemplary implementation, the system 102 may be configured to monitor the transceiver 110 placed inside an aircraft cabin and determine location of electronic tag attached to a life vest. The transceiver 110 is mounted on the robotic platform 112 that moves across the aircraft aisle. As the robotic platform 112 moves across the aisle, the transceiver 110 transmits a series of radio signal to interrogate the electronic tag. The electronic tag receives the message and then responds with its identification and other information. This information consists generally of the tag Id only. The other information may be in the form of metadata including signal phase and signal strength (RSSI). This information is collected at the receiver of the transceiver 110.

In a similar manner, all the electronic tags present in different seats keep responding to the transceiver 110, as long as the integrated circuit in the electronic tags is activated. The transceiver 110 keeps sending periodic interrogation signals. By the time, the robotic platform 112 reaches the end of the aisle, each of the RFID tag present in the cabin would have responded multiple times. The robotic platform 112 keeps track of the distance covered by it.

In one embodiment, the transceiver 110 and robotic platform 112 are connected to the system 102. In one embodiment, the system may be placed over the robotic platform 112. The processor of the system 102 is configured to capture response radio messages from each of the electronic tags and determine:
Distance: The robotic platform 112 provides the distance covered by it from a starting point
Tag Id: The response radio message from the electronic tag contains this information
RSSI: As detected by the transceiver 110
Signal phase: As detected by the transceiver 110

One robotic platform 112 moves through the aisle collects tag data (including distance and metadata) from one side of the aisle. The antenna of the transceiver 110 may be then rotated and another robotic platform 112 walk is performed to collect tag data from the remaining seats in the cabin. In multi aisle aircraft, the same process is repeated for each aisle.

In one embodiment, the metadata is formatted by the processor as a JSON record. It consists of signal phase detected by the transceiver 110, distance covered by the robotic platform, RSSI detected by the transceiver 110, antenna angle, tagId from the tag response and time at which the tag responded. The JSON format may be as follows:

{“phase”:[“135”, “78”, “151”, “171”, “149”, . . . ],

, “distance”:[“8”, “9.2”, “10.1”, “11.1248”, . . . ],

“RSSI”:[“−47”, “−49”, “−54”, “−56”, “−54”, . . . ],

“angle”:[“16.0”, “16.0”, “16.0”, “ . . . , “23.0”, . . . ],

“tag”:[“GEN2:300500FB63AC1F3681EC881E”, “GEN2:300500FB63AC1F36 81EC881D”, . . . ],

“time”:[“3620780”, “3620781”, “3620800”, “3620860”, . . . ]}

In one embodiment, the data formatted in JSON format is passed on to the system 102 using MQTT based middleware. The purpose of MQTT middleware is to decouple application from data collection. With middleware in place, the system 102 can reside either on the robotic platform 112, or over a backend server or on the cloud.

Further, the system 102 is configured to perform statistical analysis based on supervised machine learning to localize the life vests. The combined signature of signal phase, RSSI and robot distance is seen to be different for each of the tag in the area 114. Data preparation may be performed before passing on the JSON data to the system. All the response radio messages from a single tag are combined to form for input vector for that electronic tag. Each response is stored within the vector as a tuple consisting of tag Id, distance, RSSI and signal phase.

Vector (tag ID)=>{(distance1, phase1, rssi1), (distance2, phase2, rssi2), . . . }

Eg: Vector (“GEN2:300500FB63AC1F3681EC881D”) {(2.0, 35, −49), (4.5, 79, −48), (6.1, 135, −48), . . . }

Further, the system is configured to enable a Support Vector Machine for creating the statistical model. Support Vector Machine (SVM) is a supervised training classifier defined by a separating hyper-plane. In support vector machines, a data point is viewed as a p dimensional vector (a list of p numbers), and we want to know whether we can separate such points with a (p−1) dimensional hyper-plane. This is called a linear classifier. There are many hyper-planes that might classify the data. The best hyper-plane is the one that represents the largest separation, or margin. It is known as the maximum-margin hyper-plane. The first step performed by the system is training the model using any machine learning method for predictive analysis.

In one embodiment, the model, based on SVM with RBF kernel, may be trained using several sets of training data. In the training data, the location of the tags is available. With sufficient amount of training, the accuracy of the model is improved. When the test data is fed to this model, it predicts the probabilities of the tag being located in each of the available seats. Further, a probability model is built using combination of distance, signal phase and RSSI. In one example, the probabilistic model starts processing the vectors with a belief model where the tag could be in any of the available seats with equal probability. This model provides a probability for each of the sample indicating the probability that the tag is present in any of the available seats.

Further, the model refines the belief based on each entry in the vector corresponding to the electronic tag. At the end of the input samples for this tag, a clear convergence of probability is observed pointing to the target location of the tag with a high confidence.

In one embodiment, the probabilistic model may be fine tuned based on the accuracy of a model considering the percentage of tags classified accurately, confusion matrix, training error rate and test error rate with different samples of data. In one embodiment, the input data space is analysed at a higher dimensional space via a kernel function. Based on experimentation and evaluation criteria, RBF (Radial Basis Function) kernel provided the required higher dimensional hyper-plane to classify the data.

Although implementations for methods and systems for determining a location of an electronic tag in an area in real time has been described, it is to be understood that the appended claims are not necessarily limited to the specific features or methods described. Rather, the specific features and methods are disclosed as examples of implementations for determining the location of the electronic tag.

We claim:

1. A system for determining a location of an electronic tag in an area, the system comprising:
a transceiver configured for
transmitting a series of radio messages to an electronic tag in the vicinity of the transceiver, wherein the transceiver is configured to travel a distance after transmitting each radio message from the series of radio messages, and
receiving one or more response radio messages, corresponding to one or more radio messages of the series of radio messages, from the electronic tag;
a memory, and
a processor coupled to the memory, wherein the processor is configured to execute program instructions stored in the memory for:
determining, for each response radio message,
metadata corresponding to the response radio message, wherein the metadata includes a signal phase and a signal strength corresponding to the response radio message, and
a distance covered by the transceiver at the time of transmitting the radio message;
analyzing the distance covered by the transceiver and the metadata for each response radio message using a probabilistic model to determine a probability of occurrence of the electronic tag at each location associated with the area; and
identifying a target location corresponding to the electronic tag, from the set of locations in the area, based on the probability of occurrence corresponding to each location in the area.

2. The system of claim 1, wherein the area is selected from an aircraft cabinet, a shopping mall, a warehouse, and a goods store.

3. The system of claim 1, wherein the transceiver is mounted over a robotic platform, and wherein the robotic platform is configured to maneuver the transceiver to cover the distance after transmitting the radio message.

4. The system of claim 1, wherein the probabilistic model is configured to determine probability of occurrence based on a machine learning model, wherein the machine learning model is built using supervised analysis of training data.

5. The system of claim 4, wherein the training data is generated by analyzing response radio messages captured from a set of electronic tags with known location information, and wherein the machine learning model is configured to analyze the training data for generating signal characteristics corresponding to each electronic tag from the set of electronic tags.

6. The system of claim 1, wherein the metadata further comprises antenna angle of the transceiver, time of response corresponding to the response radio message.

7. The system of claim 1, wherein the electronic tag is an RFID tag.

8. A method for determining a location of an electronic tag in an area, the system comprising:
transmitting, by a processor, a series of radio messages to an electronic tag in the vicinity of the transceiver, wherein the transceiver is configured to travel a distance after transmitting each radio message from the series of radio messages, and wherein the series of radio messages are transmitted through a transceiver;
receiving, by the processor, one or more response radio messages, corresponding to one or more radio messages of the series of radio messages, from the electronic tag, wherein the one or more response radio messages are received through the transceiver;
determining, by the processor, for each response radio message,
metadata corresponding to the response radio message, wherein the metadata includes a signal phase and a signal strength corresponding to the response radio message, and
a distance covered by the transceiver at the time of transmitting the radio message;
analyzing, by the processor, the distance covered by the transceiver and the metadata for each response radio message using a probabilistic model to determine a probability of occurrence of the electronic tag at each location associated with the area; and
identifying, by the processor, a target location corresponding to the electronic tag, from the set of locations in the area, based on the probability of occurrence corresponding to each location in the area.

9. The method of claim 8, wherein the area is selected from an aircraft cabinet, a shopping mall, a warehouse, and a goods store.

10. The method of claim 8, wherein the transceiver is mounted over a robotic platform, and wherein the robotic platform is configured to maneuver the transceiver to cover the distance after transmitting the radio message.

11. The method of claim 8, wherein the probabilistic model is configured to determine probability of occurrence based on a machine learning model, wherein the machine learning model is built using supervised analysis of training data.

12. The method of claim 11, wherein the training data is generated by analyzing response radio messages captured from a set of electronic tags with known location information, and wherein the machine learning model is configured to analyze the training data for generating signal characteristics corresponding to each electronic tag from the set of electronic tags.

13. The method of claim 8, wherein the metadata further comprises antenna angle of the transceiver, time of response corresponding to the response radio message.

14. The method of claim 8, wherein the electronic tag is an RFID tag.

15. A non-transitory computer readable medium embodying a program executable in a computing device for determining a location of an electronic tag in an area, the computer program product comprising:
a program code for transmitting a series of radio messages to an electronic tag in the vicinity of the transceiver, wherein the transceiver is configured to travel a distance after transmitting each radio message from the series of radio messages, and wherein the series of radio messages are transmitted through a transceiver;
a program code for receiving one or more response radio messages, corresponding to one or more radio messages of the series of radio messages, from the electronic tag, wherein the one or more response radio messages are received through the transceiver;
a program code for determining for each response radio message,
metadata corresponding to the response radio message, wherein the metadata includes a signal phase and a signal strength corresponding to the response radio message, and
a distance covered by the transceiver at the time of transmitting the radio message;
a program code for analyzing the distance covered by the transceiver and the metadata for each response radio message using a probabilistic model to determine a probability of occurrence of the electronic tag at each location associated with the area; and
a program code for identifying a target location corresponding to the electronic tag, from the set of locations in the area, based on the probability of occurrence corresponding to each location in the area.
